(19) United States
(12) Patent Application Publication
(10) Pub. No.: US 2019/0236142 A1
(43) Pub. Date: Aug. 1, 2019

(54) System and Method of Chat Orchestrated Visualization

(71) Applicant: Crowdcare Corporation, Richmond Hill (CA)

(72) Inventors: Karthik Balakrishnan, Etobicoke (CA); Jeffrey Brunet, Aurora (CA); Yousuf Chowdhary, King City (CA); Karen Chan, Richmond Hill (CA); Ian Collins, Markham (CA)

(21) Appl. No.: 16/262,176

(22) Filed: Jan. 30, 2019

Related U.S. Application Data
(60) Provisional application No. 62/624,867, filed on Feb. 1, 2018.

(51) Int. Cl. G06F 17/27; G06N 3/08

(52) U.S. Cl. CPC G06F 17/2785; G06N 3/088

(57) ABSTRACT

A method is provided for chat orchestrated visualization. In response to a substantive user communication received in the chat session, the system decomposes the terms of the communication into components. From at least one of the components, an intent of the communication is determined and a search is formulated with the intent which is searched in a plurality of data sources to obtain raw search results which are stored in a cache. Natural language understanding (NLU), natural language generation (NLG) or generative neural nets (GNN) may be used to generate a short text response to the user communication, and related web content is synthesized in text and other forms. The short response is displayed in the chat session while the synthesized web content is injected and displayed in a passive window, such that the chat session and the web content are displayed in different portions of the same screen.

### FIELD OF INVENTION

The invention in general relates to customer care and in particular relates to providing relevant information to customers based on a chat conversation.

### BACKGROUND OF THE INVENTION

Current customer service channels for communications with customers include the use of chat among other mechanisms, such as phone, e-mail, web-based FAQs, etc. The current state of chat is rapidly evolving, and there is an increasing use of “chatbots” where a portion of the conversation is computer-driven in an effort to reduce the manpower required to deal with support issues.

Oftentimes the chat window is too small to fit much text and graphic content. Thus, the CSR or a chatbot may typically insert a URL link into the conversation in order to provide the customer with more detailed information. The customer is expected to click the link which then leads them to a webpage with more detailed information displayed in a browser window. This method relies on the customer to click the link inserted in the chat conversation to get to the next level of detail for the issue that they may be trying to resolve. In so doing, the chat session can typically get lost or shut down and/or inserting several links can quickly overwhelm the small content window of the chat.

A simpler system is needed without sacrificing the ability to provide detailed content to users. The prior art click driven experiences would be vastly improved by being replaced with conversation driven experiences.

### SUM MARY

Broadly speaking, the present invention provides a method and a system of chat orchestrated visualization where a customer is provided relevant information in response to a query in a chat conversation. The information relevant to the intent of the user query is injected into the contents of a web-browser or other app window and is refreshed as the chat conversation evolves.

The present system provides a conversation driven experience vastly improving the click driven experience that is currently offered by prior art methods through the ability to serve pointed and accurate information preferably generated in response to a customer query in a chat instead of injecting a URL or link in the chat conversation where the user is expected to click the link to get to more detailed information.

The intent of the chat conversation drives the content displayed to the customer in a browser or other app window. As the chat conversation evolves so does the content in the browser in response.

Intent-based content from a varied set of sources may be used to refresh the information in a browser/app window. The information that is injected into the browser in response to a user question or query is gathered by analyzing the user query for its intent, and succinct information is provided as a response. The information may be personalized and in some cases synthesized from a wide set of information sources in light of user behaviour and other factors relevant to the situation or timeframe.

A customer or a user inputs a query or question into a chat window. The customer query is then parsed and decomposed into components. A remote server may be used to parse and decompose the customer query into components using Natural Language Processing. Natural Language Processing (NLP) is a computational method for analyzing the language of electronic texts, interpreting their linguistic content and extracting information from them that is relevant for specific tasks. In one embodiment of the invention, the NLP system segments the question into linguistically significant units (sentences, clauses, phrases, tokens) and determines the semantic significance of these units. The semantic significance of these units is not only determined by their near and long-distance linguistic context but also by the linguistic situation in which the question has been asked.

NLP may be used to extract the intent/issue from the query/question inputted by the customer into the chat window. Intent in this context can be defined as the reason or purpose of asking the question. Intent can also imply the state of a person's mind that has asked the question.

The extracted issue/intent can then be correlated with the content in the system. The correlation of the intent with the content in the system for customer support or other relevant aspect of a business may be determined by first searching the data sources using the intent.

An answer is provided in the chat session based on the correlation, and content is provided in the browser/app that is relevant to the intent determined from the user query.

The browser information may be refreshed by invoking web widgets. In another embodiment, the browser information is refreshed by manipulating page elements e.g. Document Object Model (DOM) elements using JavaScript or the like.

In one embodiment, an app that may be installed on a mobile device is used by a customer to ask a question about a product or a service that the organization e.g. a mobile network operator may be providing to the said user. In this disclosure customer questions/comments/complaints are also collectively referred to as customer question or query.

The system may also acquire and use contextual information from the user devices e.g. mobile phone, SmartTV and the OSS/BSS to increase the accuracy of the assembled information.

According to a first aspect, a method is provided for chat orchestrated visualization through the generation of enhanced automatic responses to user communications received in a chat session where the chat session is embedded in a passive window. In response to a user communication received in the chat session, the system determines whether the communication is small talk or substantive, and if substantive, decomposes the terms of the communication into components. From at least one of the components, an intent of the communication is determined and a search is formulated with the intent which is searched in a plurality of data sources to obtain raw search results which are stored in a cache. Eliminated from the cache are: raw search results that are excessively distal from the intent; redundant raw search results; and non-informative raw search results. At least one of the following is applied to the remaining search results: natural language understanding (NLU), natural language generation (NLG) or generative neural nets (GNN). Through this, a short text response is generated to the user communication, and related web content is synthesized in text and other forms. The short response is displayed in the chat session while the system simultaneously injects and displays the synthesized web content in the passive window, such that the chat session and the web content are displayed in different portions of the same screen.

If the communication is small talk (i.e. conversational snippets such as “Please”, “Thank you”, “Hello” or “Goodbye”), the system generates and displays in the chat session a scripted response without changing the passive window.

The web content may be invoked through a web widget.

The passive window may be a browser or an app (purpose built or part of another system, such as an account maintenance or shopping app).

At least a portion of the short response (answer) and/or the web content may be converted to voice output and playing it to the user.

The terms of the user communication may be received by typing text. In some embodiments, the terms of the user communication are received by voice input which may then be converted to text

In some embodiments, the terms of the user communication may be concatenated with other information gathered from the user's device or from an account associated with the user. In these cases, the intent may be determined from (or taking into account) the information gathered from the user's device or account.

Preferably, the decomposing step uses natural language processing (NLP).

The intent is preferably determined using an intent classifier. The intent classifier may be a module or algorithm within an artificial intelligence engine.

When a substantive second user communication is received, the system may repeat the steps of the method, in which case at least a portion of the web content is modified or replaced in response to the second user communication. The web content is modified or replaced without closing or leaving the chat session. The second response is preferably informed by the communications in the chat session up to that point. The second response is preferably generated or edited so as not to be redundant with the first response. In some embodiments, the cache is cleared between user communications.

Devices that can benefit from the present system may include but are not limited to a mobile device for example a Smartphone, a tablet, a computer, a server, network appliance, set-top box, SmartTV, embedded device, computer expansion module, personal computer, laptop, tablet computer, personal data assistant, game device, e-reader, any appliances having internet or wireless connectivity and onboard automotive devices such as navigational and entertainment systems and any kind of other computing devices.

Part of the impetus for the invention lies in the fact that there are hundreds of thousands of varied data/information sources, and it is humanly not possible to analyze all of them for relevance. For example, a sentence or a paragraph in a seemingly unrelated article may be relevant for answering a question; the remainder of the article would be irrelevant and the invention is capable of taking the relevant passage(s) and combining them with other relevant passages from other articles to synthesize a succinct answer. Thus, by machine reading the informative elements and automatically including a select set of relevant ones while discarding other non-relevant ones, better results can be achieved.

### BRIEF DESCRIPTION OF THE FIGURES

FIG. 1 is a flow diagram illustrating a basic process for chat orchestrated visualization.

FIG. 2 is a flow diagram illustrating in more detail a preferred embodiment of a process for chat orchestrated visualization.

FIG. 3 is a logical diagram illustrating one embodiment of the dynamic process for display of chat answer and relevant content in a browser or app (passive window).

FIG. 4 is a flow diagram illustrating ongoing process of chat orchestrated visualization and refreshing of the answers and content.

FIG. 5 is a sample screenshot illustrating a back-and-forth dialog in the chat window while a multi-part content is generated and displayed in an adjacent passive window.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a mobile device or partly on the mobile device as a stand-alone software package; partly on the mobile device and partly on a remote computer or remote computing device or entirely on the remote computer or server or computing device. In the latter scenario, the remote computer may be connected to the mobile device through any type of network, including a local area network (LAN) or a wide area network (WAN), or the connection may be made to the internet through a mobile operator network (e.g. a cellular network).

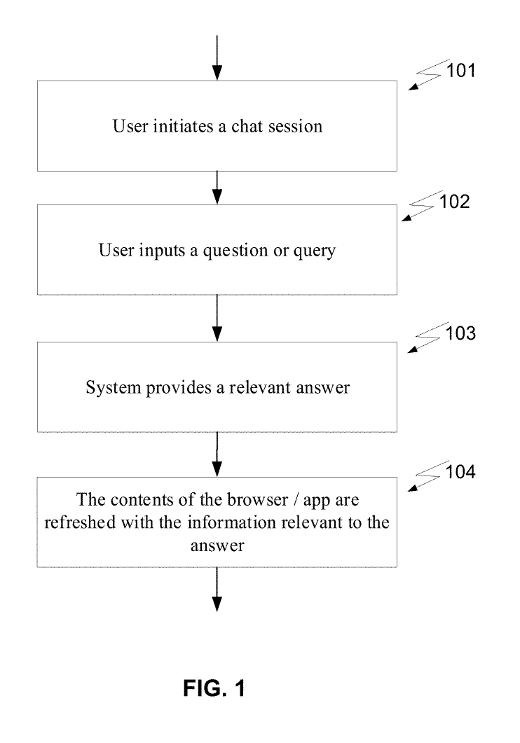

A system and method is provided of chat orchestrated visualization where the intent of a customer question or query is used to refresh the content of a browser or app window providing information that is relevant and helps solve the customer issue. FIG. 1 shows a basic embodiment of the method.

A user/customer initiates a chat session 101. A customer may initiate a chat session with a company such as a service or product provider. The chat may be driven by Al (Artificial

Intelligence) where some part or all of the chat responses to the customer queries are driven by bots or similar entities.

In one embodiment an app (e.g. installed on a mobile device) is used by a customer to initiate a chat to ask a question about a product or a service that the organization e.g. a mobile network operator is providing. In this disclosure customer questions/comments/complaints are also collectively referred to as customer question or query.

In one embodiment a customer may use a desktop or any other device e.g. a SmartTV or the like where a browser and associated technologies may be installed to initiate a chat.

The user inputs a question or query 102 into a chat window which is received by a remote server. The chat tool may be accessed by a customer either on a desktop computer or other device where a browser is installed or via an app that may be installed on a mobile device e.g. a Smartphone or a tablet. The remote server may be accessible over a network e.g. Internet or LAN (Local Area Network). The server may be a standalone computer that is connected to the internet or other network or it may be a set of networked computing devices.

In one embodiment of the invention the functionality of the app of invention may be embedded in another app or software application that is installed on a device. In one embodiment of the invention the app of invention may be downloaded from an AppStore.

The system then converts the customer query, question or complaint into text if the original was in non-text format for example voice. In some embodiments the customer asks the question in a text format by typing or using a touch screen interface on a mobile device like a Smartphone or a tablet. In other embodiments the customer may ask the question using voice (or vocal commands) and the communication may be converted to text format using Speech to Text technologies. Other embodiments may use other methods of input suitable to other devices.

The system may also acquire and use contextual information from linked user devices e.g. mobile phone, SmartTV and the OSS/BSS to increase the accuracy of the assembled information that is injected into the browser. Examples of how device and/or account parameters are used to enhance a search are described and taught in applicants' previous U.S. patent application Ser. No. 14/595,271 (System and Method of Search for Improving Relevance Based on Device Parameters), filed on Jan. 13, 2015, the contents of which are incorporated by reference.

For example, information that can be gathered from the device may include but is not limited to: the device make, model and manufacture information, OS and firmware versions; applications (commonly referred to as “apps”) installed on the device; apps and processes running on the device; certificates on the device; user profile information; the character of any passcode used to authenticate a user (e.g. whether a password/passcode is used and the relative strength of that password, such as the number of characters); information regarding whether the device operating system has been tampered with by the user (e.g. an iOS device has been jailbroken, or a Google Android device has been rooted); and the data usage e.g. the amount of MB or GB used for a given billing period, the amount data used while roaming, or the relative amount compared to a data plan used by the user, stored WiFi networks, devices paired with a Bluetooth connection, etc.

The device information may be gathered and sent at the same time as a customer asks a question, or on demand at a later time after the customer has asked a question or made a complaint.

In addition to the device information e.g. device make, model, OS and firmware versions etc., the system may also extract information like the error logs, types of errors, number of errors in an error log, severity of errors, number and frequency of crashes of the device etc.

A relevant answer to the customer question, query or complaint is provided by the system 103.

The chat conversation may be entirely conducted by a chatbot. A chatbot or Artificial Conversational Entity is a computer program or application that conducts a conversation with a human user through text or voice. Chatbots are designed to simulate a human conversation.

The contents of the browser/app are refreshed with information relevant to the short answer 104 provided to the customer in response to their earlier query or question.

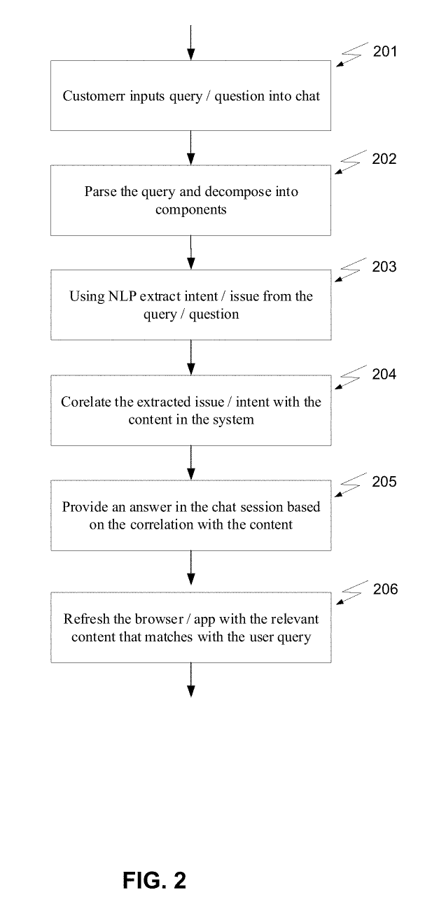

FIG. 2 shows a more detailed preferred embodiment of the method 200.

The customer inputs a query/question into the chat window 201. The customer may input the query using text or voice or the use of other means.

The query is parsed and decomposed into components 202. In one embodiment this is done using Natural Language Processing. Natural Language Processing (NLP) is a computational method for analyzing the language of electronic texts, interpreting their linguistic content and extracting information from them that is relevant for specific tasks. The NLP system preferably segments the question into linguistically significant units (sentences, clauses, phrases, tokens) and determines the semantic significance of these units. The semantic significance of these units is not only determined by their near and long-distance linguistic context but also by the linguistic situation in which the question has been asked.

To demonstrate the use of natural language processing here, take the following example:
“Hi. why does my phone use data when I'm on wifi? Thank you.”

This query can be split into 3 sentences. Each sentence is then “tokenized”: punctuation is separated from the words, contractions are separated into separate words. The sentences are categorized (ignorable vs not ignorable), and the key sentences are retained.

So, from the initial question, the following is retained:
“Hi. why does my phone use data when I'm on wifi? Thank you.”

The words in the sentence are assigned parts of speech:
“posResults=[why_WRB does_VBZ my_PRP$ phone_NN use_VB data_NN
when_WRB i_PRP′m_VBP on_IN wifi_NN._.]”

Where the parts of speech indicate the syntactic role of the words and become input for the semantic parser:
NN=singular noun
PRP$=possessive adjective
PRP=personal pronoun
IN=preposition
VBZ=third-person singular verb
WRB=interrogative adverb

The sentence is then processed with a dependency grammar parser which groups the words into meaningful phrases and labels their semantic roles:
(TOP (SBARQ (WHADVP (WRB why)) (SQ_CAUSE (VBZ does) (SUBJECT (NFOOT (DP (PRP$ my))) (NHEAD (NN phone))) (ACTION (VHEAD (VB use))) (OBJECT (NHEAD (NN data))) (SBAR (WHADVP (WRB when)) (S (SUBJECT (NHEAD (PRP i)))(STATE (VHEAD (VBP′m))) (IN on) (COMPLEMENT (NHEAD (NN wifi)))))) (. .)))

Thus, these semantic fields are assigned to the sentence:
ACTION: use
SUBJECT: phone
OBJECT: data
COMPLEMENT: wifi

Using NLP, the intent/issue can then be extracted or determined from the query/question 203. Intent in this context can be defined as the reason or purpose of asking the question. Intent can also imply the state of a person's mind that has asked the question.

A piece of unstructured text can be analyzed using Natural Language Processing, the subsequent concepts are analyzed for an understanding of these words and how they relate to the intent of the question asked by the user. An intent may be defined as a reason why the user may have asked the question in the first place.

Let's take an example of user message: “Help me find a Chinese restaurant in New York”. The human mind quickly infers this to be someone wanting to find a restaurant that serves Chinese cuisine.

Machines train to perform “Natural Language Understanding”, i.e. intent classification, by observing a number of examples that would show how people might ask for a restaurant, and then building a mathematical representation of the same in vector space. The below are examples of how one might train a machine for identifying a request to find a restaurant:

Training data example for intent classification:

| Utterance | Tag (intent) | Named entities |
|---|---|---|
| help me find a restaurant | find_restaurant | None |
| i want to eat at an Indian | find_restaurant | restaurant_type = “Indian” |
| restaurant | | |
| help me find a chinese | find_restaurant | restaurant_type = “Chinese”, |
| restaurant in New York | | city = “New York” |

“Named entity extraction” is another sub step performed by intent classification systems in the process of natural language understanding. NLU systems explicitly train for named entity extraction, as part of the broader intent classification process. Named entities help refine the intent further, by extracting parameters from the original query. This way, the system can exhibit greater cognisance of the ask and thereby return more targeted and pin-pointed answers. For example, when the user asks “Help me find a Chinese restaurant in New York”, the system now understands that the user intent is “find_restaurant”, and the query parameters are “restaurant type=‘Chinese’, city=‘New York’”.

Now the system can find restaurants that only serve Chinese food and are based in New York, rather than searching the entire database for restaurants.

Machine Learning for intent classification may involve statistical approaches, deep learning approaches or a combination of both. One approach may involve using a Maximum Entropy model or a Naive Bayesian model for intent classification as well as named entity extraction. Another approach may involve using a TextCNN, i.e. a deep learning based approach for intent classification and a Hidden Markov Model for named entity extraction. In yet another approach, the user's question may be denoised by chunking the question into “noise” and “information” using sentence chunking or sentence detection models and then intent classification may process only the part of the sentence tagged as “information”, using a combination of techniques mentioned above.

The extracted issue/intent is then correlated with content in the system 204. This may be done by first searching the data sources using the intent.

Different data sources may be searched. The data sources can be internal or external and may include but are not limited to the internet, intranets, forums, groups, knowledge sources like Wikipedia available both publicly and privately etc. The intent is to cover all possible sources of information that may be relevant and used for given situations. Thus, what sources of information are searched may also vary from situation to situation.

An answer is provided in the chat session based on the correlation with the content 205.

Natural Language Understanding (NLU) is a subtopic in Natural Language Processing (NLP) which focusses on how to best handle unstructured inputs such as text (spoken or typed) and convert them into a structured form that a machine can understand and act upon. The result of NLU is a probabilistic understanding of one or more intents conveyed, given a phrase or sentence. Based on this understanding, an Al system then determines an appropriate disposition.

Natural Language Generation on the other hand, is the NLP task of synthesizing text-based content that can be easily understood by humans, given an input set of data points. The goal of NLG systems is to figure out how to best communicate what a system knows. In other words, it is the reverse process of NLU.

Generative Neural Nets or Generative Adversarial Networks (GAN) is an unsupervised learning technique where given samples of data (e.g. images, sentences) an Al system can then generate data that is similar in nature. The generated data should not be discernable as having been artificially synthesized.

Using one or a combination of the above-mentioned technologies, the system may formulate a solution (answer) that best addresses the user's question.

In one embodiment the answer provided to the customer in the chat session and the information that is refreshed in the browser window may be synthesized from different sources using Natural Language Processing. One method for doing such synthesis of data sources is described and taught in applicants' previously filed U.S. patent application Ser. No. 16/203,756 (Intent based dynamic generation of personalized content from dynamic sources), filed Nov. 29, 2018, which is incorporated herein by reference.

The system refreshes the browser/app with relevant content that matches the user query 206.

In one embodiment the browser information is refreshed by invoking web widgets. A web widget is a small stand-alone software application usually with a limited set of functionality that can be installed and executed within a web page. A web widget usually occupies a portion of a webpage and does something useful with information fetched from other websites and displayed in the said place.

A mobile web widget has the same purpose and function as a web widget, but it is made for use on a mobile device such as mobile phone or tablet.

In another embodiment the browser information is refreshed by manipulating page elements e.g. Document Object Model (DOM) elements using JavaScript or the like. The Document Object Model (DOM) is a cross-platform and language-independent application programming interface that treats an HTML, XHTML, or XML document as a tree structure wherein each node is an object representing a part of the document. The objects can then be manipulated programmatically and any visible changes occurring as a result may then be reflected in the display of the document.

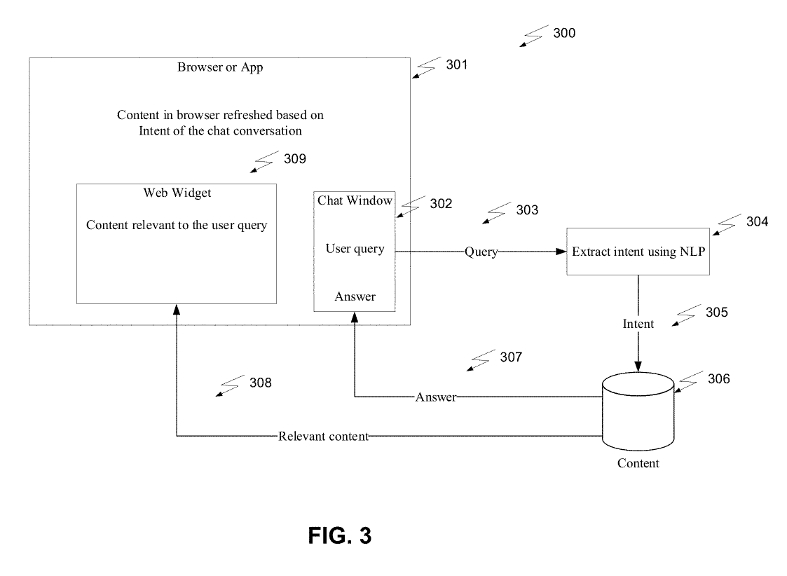

FIG. 3 shows a logical diagram illustrating one embodiment of the dynamic process for display of chat answer and relevant content in a browser or app (passive window) 300.

As shown in FIG. 3, a user may have a passive browser window 301 and a chat window 302 where the actual chat conversation is being conducted. The chat responses are preferably driven by a chatbot but in some cases, may be taken over by a customer service representative if required. The user enters a query 303 or a question into the chat window. The query may be entered using text or voice. If the query is entered as voice, then it may be preferably converted to text in the system. The user query received by the chat session is sent to the server 304 where Natural Language Processing may preferably be used to extract the intent from it. The intent 305 is then used to search a database of content 305. The answer relevant to the user query or question 307 is injected into the chat conversation and content relevant to the user query 308 that may be best displayed in a browser or an app window and is too large for the chat window is injected into the web widget 309.

As the user conversation progresses and more queries or questions are entered in the chat window, the content of the web-widget in the browser or a mobile app is refreshed to depict the relevant information to assist the user with resolving the issue or problem that they may be facing.

In another embodiment, the relevant information that is injected in the web-widget may preferably be personalized to suit the particular situation of a customer asking the question.

Using the intent determined from the question asked by the user, the system searches different data sources 306. The data sources can be internal or external and may include but are not limited to the internet, intranets, forums, groups, knowledge sources like Wikipedia available both publicly and private etc. The system gathers various potential solutions or articles with information relevant to the question.

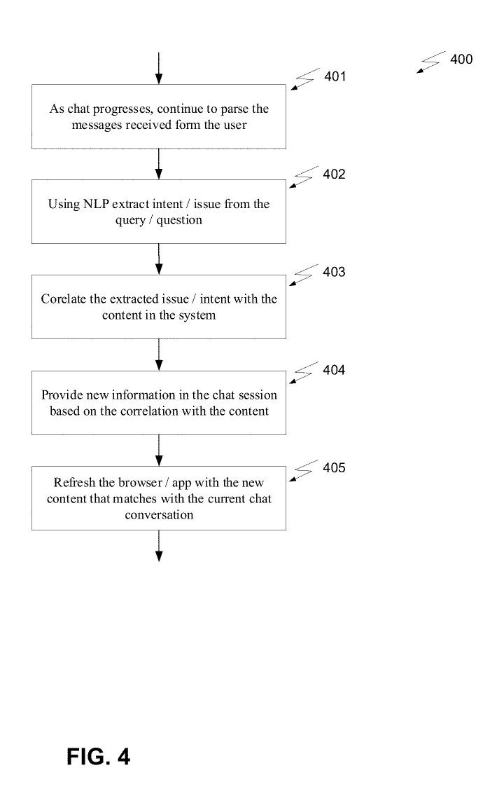

FIG. 4 shows an embodiment of the invention with ongoing chat and multiple refreshes of the passive window 400. As chat progresses, the system continues to parse the messages received from the user 401.

Preferably, using NLP the intent/issue is extracted from the query/question 402 entered by the user in the chat window.

The extracted issue/intent can then be correlated with content in the system 403 e.g. content relevant to products and/or services stored in a Content Management System or a database or the like. In some embodiments the system may also search for information outside of the system e.g. by performing searches on the internet and extracting the information deemed relevant to the intent of the user query.

The system then provides new answers in the chat session and displays relevant content 404 based on the correlation with the evolving chat conversation.

As needed, the browser/app is refreshed with the new content relevant to the current chat conversation 405.

In one embodiment the answer may be displayed in textual form to the user for example as text on the screen of a device. In another embodiment the text answer may be converted into voice and played for the user (e.g. using a text-to-speech module).

Note that not all chat interactions will necessarily trigger such an intensive processing and search resulting in a refreshed browser/app content. In some cases, the chat input can be responded to strictly in the chat window as scripted “small talk” (e.g. hello, goodbye, thanks, etc.). Such small talk responses may be provided through the chatbot functionality and its related databases.

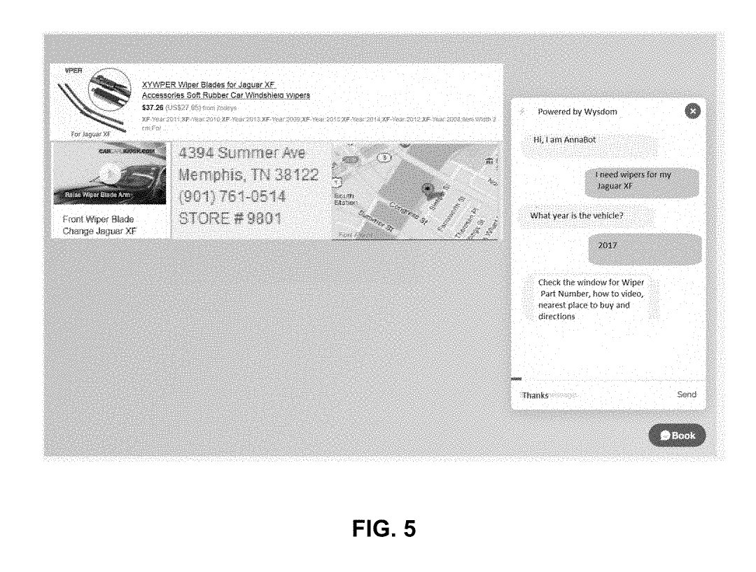

FIG. 5 is a sample screenshot illustrating a back-and-forth dialog in the chat window while a multi-part content is generated and displayed in an adjacent passive window. As shown in the Figure, the following exchange occurs in the chat session:
I need wipers for my Jaguar XF
   What year is the vehicle?
2017
   Check the window for Wiper Part Number, how to video, nearest place to buy and directions
Thanks

As shown in the Figure, the passive window (here, a browser) displays a product (here, XYWper Wiper Blades for Jaguar XF) determined to be relevant to the intent of the query “I need wipers for my Jaguar XF” with the additional information of the year “2017”. In addition, a relevant video on replacing the front wiper blade of this vehicle model is provided as well as a map of a local Jaguar technician. All of the web content (product listing with graphic, video, and map) are provided as discrete but simultaneously displayed elements in the browser, and the chat session is also displayed on the right side of the screen (i.e. chat does not shut down or disappear when the web content is displayed). No links need to be clicked from the chat session to visualize this content. Note also that certain content of the chat session (“Hi, I am AnnaBot” and “Thanks”) are categorized as small talk that does not separately affect the web content that is displayed.

Devices that can benefit from the system of the invention may include but are not limited to a mobile device for example a Smartphone, a tablet, a computer, a server, network appliance, set-top box, SmartTV, embedded device, computer expansion module, personal computer, laptop, tablet computer, personal data assistant, game device, e-reader, any appliances having internet or wireless connectivity and onboard automotive devices such as navigational and entertainment systems. Such devices may also benefit from the fact that there are hundreds of parameters and by machine reading the data elements and automatically including a select set of relevant parameters in a search query ensures increased accuracy.

It should be understood that although the terms browser/web-widget/app have been used as an example in this disclosure but in essence the term may also apply to any other piece of software code where the embodiments of the invention are incorporated. The software app or application can be implemented in a standalone configuration or in combination with other software programs and is not limited to any particular operating system or programming paradigm described here. Thus, this invention intends to cover all apps, software packages and user interactions described above as well as those obvious to the ones skilled in the art.

The program code may execute entirely on a mobile device or partly on the mobile device as a stand-alone software package; partly on the mobile device and partly on a remote computer or entirely on the remote computer or server. In the latter scenario, the remote computer may be connected to the mobile device through any type of network, including a local area network (LAN) or a wide area network (WAN), or the connection may be made to the internet through a mobile operator network (e.g. a cellular network).

Several exemplary embodiments/implementations of the invention have been included in this disclosure. There may be other methods obvious to the ones skilled in the art, and the intent is to cover all such scenarios. The application is not limited to the cited examples, but the intent is to cover all such areas that may be benefit from this invention. The above examples are not intended to be limiting, but are illustrative and exemplary.

What is claimed is:

1. A method of generating enhanced automatic responses to user communications received in a chat session, the chat session being embedded in a passive window, comprising the steps of:
in response to a user communication being received in the chat session, determining if the communication is small talk or substantive;
if substantive, decomposing the terms of the communication into components;
from at least one of the components, determining an intent of the communication and formulating a search with the intent;
searching for the intent in a plurality of data sources and obtaining raw search results and storing these in a cache;
eliminating from the cache:
raw search results that are excessively distal from the intent;
redundant raw search results; and
non-informative raw search results;
applying at least one of natural language understanding (NLU), natural language generation (NLG) or generative neural nets (GNN) to the remaining search results in the cache to:
generate a short text response to the user communication; and
synthesize related web content in text and other forms; and
displaying the short response in the chat session while simultaneously injecting and displaying the synthesized web content in the passive window, such that the chat session and the web content are displayed in different portions of the same screen.

2. The method of claim 1, wherein if the communication is small talk, generating and displaying in the chat session a scripted response without changing the passive window.

3. The method of claim 1, wherein the web content is invoked through a web widget.

4. The method of claim 1, wherein the passive window is a browser.

5. The method of claim 1, wherein the passive window is an app.

6. The method of claim 1, further comprising converting at least a portion of the short response and/or the web content to voice output and playing it to the user.

7. The method of claim 1, wherein the terms of the user communication are received by typing text.

8. The method of claim 1, wherein the terms of the user communication are received by voice input.

9. The method of claim 1, wherein the terms of the user communication are concatenated with other information gathered from the user's device or from an account associated with the user.

10. The method of claim 9, wherein the intent is determined from the information gathered from the user's device or account.

11. The method of claim 1, wherein the decomposing step uses natural language processing (NLP).

12. The method of claim 1, wherein the intent is determined using an intent classifier.

13. The method of claim 12, wherein the intent classifier is within an artificial intelligence engine.

14. The method of claim 1, further comprising receiving a substantive second user communication and repeating the steps of the method, wherein at least a portion of the web content is modified or replaced in response to the second user communication.

15. The method of claim 14, wherein the web content is modified or replaced without closing or leaving the chat session.

16. The method of claim 14, wherein the second response is informed by the communications in the chat session up to that point.

17. The method of claim 16, wherein the second response is generated or edited so as not to be redundant with the first response.

18. The method of claim 14, wherein the cache is cleared between user communications.
